(19) United States
(12) Patent Application Publication
(10) Pub. No.: US 2009/0070319 A1
(43) Pub. Date: Mar. 12, 2009

(54) System and method for offering content on a mobile device for delivery to a second device

(75) Inventor: Andreas Hronopoulos, La Jolla, CA (US)

Correspondence Address: KENYON & KENYON LLP, ONE BROADWAY, NEW YORK, NY, 10004, US

(73) Assignee: La Touraine, Inc.

(21) Appl. No.: 11/900,807

(22) Filed: Sep. 12, 2007

(51) Int. Cl. G06F 17/30

(52) U.S. Cl. 707/5; 707/E17.008

(57) ABSTRACT

A system and method of matching content for a customer and offering the content to the customer on a mobile device and downloading the content on a customer device is disclosed. The matching of the content may include matching a customer with categories and the content with categories. The system may include sizing the matched content in portion to the size of the display of the mobile device.

### BACKGROUND INFORMATION

Many customers purchase Video-on-Demand (VOD) from service companies. The service companies have many problems servicing the customer. First, the video may be large compared to the ability of the network connected to the viewing device to deliver the content, so the customer often cannot order the video and then immediately watch the video. Second, there are many different videos for the customer to choose from. The customer often gets frustrated trying to find videos that they would enjoy watching, or the customer may end up watching a video that is less enjoyable and thus the customer may be less likely to purchase a video in the future. The customer, also, often has limited time to search for content that would best serve them. This can result in lost revenue to the service company if the customer is not satisfied. Third, there is a constant stream of new content that the customer may want to watch, and may want to watch immediately upon receipt by the service company, but the customer may not become aware of the new content in time to view the content in a timely fashion.

### BRIEF DESCRIPTION OF THE DRAWINGS

FIG. 1 illustrates an example system, according to an example embodiment of the present invention.

FIG. 2 illustrates an example content server, according to an example embodiment of the present invention.

FIG. 3 illustrates an exemplary user screen, according to an example embodiment of the present invention.

FIG. 4 illustrates another exemplary user screen, according to an example embodiment of the present invention.

FIG. 5 illustrates an exemplary user interaction, according to an example embodiment of the present invention.

FIG. 6 illustrates an example data flow, according to an example embodiment of the present invention.

FIG. 7 illustrates an example method for sizing the matched content in proportion to the size of the display device of the mobile device, according to an example embodiment of the present invention.

FIG. 8 illustrates an example method for offering content on a mobile device and downloading content to a customer device, according to an example embodiment of the present invention.

### DETAILED DESCRIPTION

Some example embodiments of the present invention include methods and systems for content selection and distribution. Some of these embodiments are directed, in particular, to the selection of content from a mobile device for distribution to a second device, possibly for viewing at a later time and in a different location. Some of the example embodiments include systems and methods that can determine what a customer would like to watch and deliver it to the customer so that the customer can immediately begin watching the content when the customer is available to view the content on the viewing device. This may be achieved by identifying information about content, e.g., newly available content, that a customer may enjoy and providing a notification about this content to the user's mobile device. The user can then order the content they find interesting and have it pre-loaded at some other location, e.g., their home computer, set-top box, or digital television, so that is immediately available when the user reaches the other location.

Some of the example embodiments, described in more detail below, may provide one or more of the following advantages:

by presenting content choice on a mobile device, additional customer purchase of content may be stimulated;

by allowing pre-selection of content, content can be pre-loaded for a customer, improving content viewing and download performance;

by having content pre-loaded at a location before a user's arrival, customer may view high quality content without waiting for downloading, or using lower quality streaming or progressive downloading;

by matching customer attributes with content, content selection can be made practical and less time-consuming, even on small mobile devices, particularly when compared with large catalogs or unguided search, which may be impractical on a small mobile device;

by adjusting the display of announcements and queries related to available content, the system may operate more effectively on small mobile devices, improving customer acceptance and response rate;

by using GPS or other location capability of mobile devices, content offers may be triggered or selected based on the current or previous location of a customer, thus offers could also be triggered a short interval before a customer arrives at the location where content would be downloaded, which may, in turn, improve customer response rate.

One example embodiment of the present invention is a method for delivering content to a customer device. The method includes storing a customer profile; matching the content with the customer profile to produce matched content; sending to a mobile device via a network servicing the mobile device a query whether the customer would like to download the matched content; responsive to the query, receiving a request from the customer to download the content; and responsive to the request, downloading the content to the customer device over a network servicing the customer device.

In the method, the mobile device may be a cell phone. In the method, the content may be video.

In the method, sending to a mobile device may further include sending a preview of the content to the mobile device.

In the method, matching may further include receiving new content at the server; matching the new content with the customer profile; and responsive to the matching, sending to the mobile device a query whether the customer would like to download the matched content.

In the method, the matching may also further include matching a category to a customer based on the customer profile; matching the category to the content; and matching the customer profile to the content based on the matched category.

In the method, the customer profile information may be selected from the customer demographic information, customer indicated preferences, customer viewing history, and customer purchase history for non-content purchases, and customer viewing history at an Internet Website.

In the method, the matching may further include sending to the mobile device a query to determine whether the customer is a member of a category; receiving from the customer a response to the query; and modifying a customer profile based upon the user response to the query.

In the method, the network servicing the customer device may be different than the network servicing the mobile device. In the method, the customer device may be a set-top box.

The method may also include selecting advertising based on the content and embedding advertising in the content before downloading the content.

The method may also include inferring a category for the customer based on the customer profile.

The method may also include receiving a location on the surface of the Earth of the mobile device and inferring a category for the customer based on the location.

The method may also include receiving location information from the mobile device and inferring a category of the customer from the location information received from the mobile device.

In the method, the sending may include sending to an instant messenger program. In the method, the matching may be based on at least the preferences of a buddy of the customer.

In the method, the customer profile may include preferences and requests for alerts configurable by the customer.

In the method, the matching may further include narrowing the matched content based on a size of a display of the mobile device.

In the method, the matching may further include repeating until the matched content can be offered on one screen of the mobile; sending to the mobile device a query to determine whether the customer is a member of a category; receiving from the customer a response to the query; and narrowing the matched content based upon the user response to the query.

In the method, the mobile device may be a cell phone, and the content may be video, and the network servicing the customer device may be different than the network servicing the mobile device. The customer device may be located at a different geographical location than a present geographical location of the mobile device. The method may further include receiving new content at the server; matching the new content with the customer profile based on customer profile information, the customer profile information including the customer's viewing history at an Internet Website. The sending of the query to the mobile device may be performed responsive to the matching.

Another example embodiment of the present invention is an article of manufacture including a computer-readable medium having stored thereon instructions configured to be executed by a processor, the instructions configured to, when executed by the processor, to cause the performance of a method. The performed method may include storing a customer profile; matching the content with the customer profile to produce matched content; sending to a mobile device via a network servicing the mobile device a query whether the customer would like to download the matched content; responsive to the query, receiving a request from the customer to download the content; and responsive to the request, downloading the content to the customer device over a network servicing the customer device.

The performed method may further include receiving new content at the server; matching the new content with the customer profile based on customer profile information. The customer profile information may include the customer's viewing history at an Internet Website. The sending of the query to the mobile device may be performed responsive to the matching.

Another example embodiment of the present invention is a system. The system may include a customer mobile device configured, responsive to receipt of a notification, to present a customer with the opportunity to order a newly available content, the mobile device further configured, responsive to a customer input indicating the customer's desire to order the newly available content, to send a message indicating the customer's desire to order the newly available content; a second customer device separate and apart from the customer mobile device; and a server in communication via a network with the customer mobile device and the second customer device. The server may be configured to receive the newly available content and to send, via the network, the notification of newly available content to the customer mobile device. The server may be further configured, responsive to receipt of the message, to cause the content to be downloaded to the second customer device.

The system may further include a software component configured to receive customer attribute information, and based on the customer attribute information, to select the newly available content from a set of newly available content.

In the system, the customer attribute information may include information reflecting the customer's Internet viewing history.

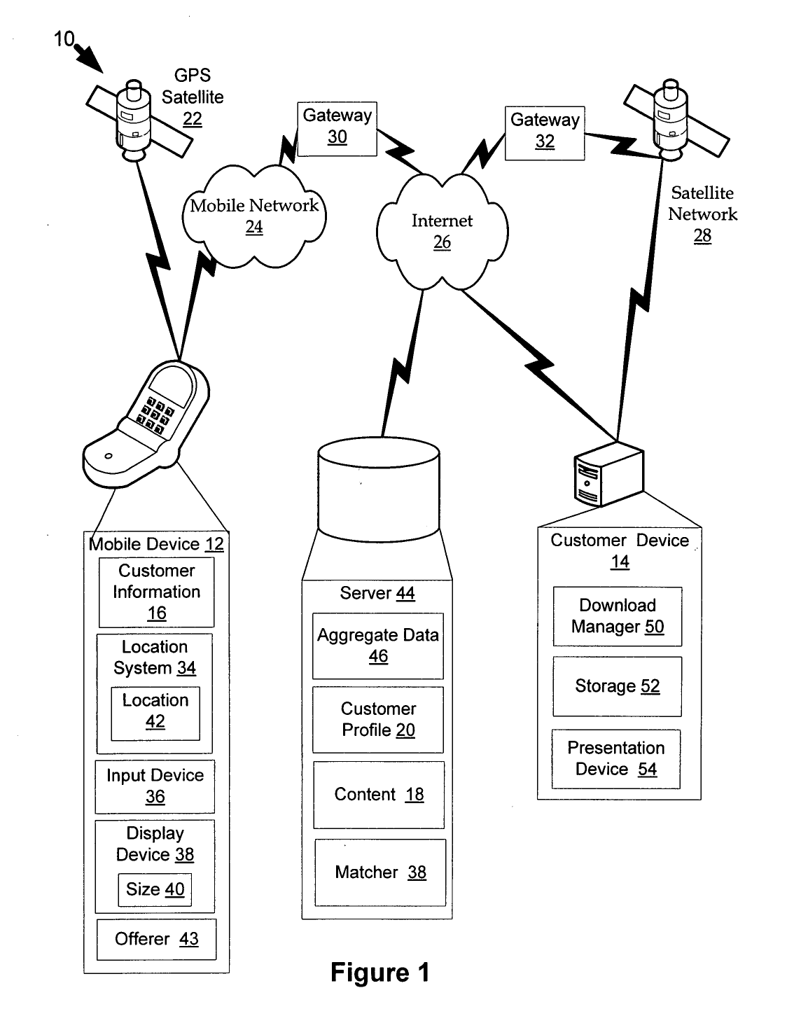

FIG. 1 depicts one example embodiment of a system 10 for offering content to a customer on a mobile device 12 for delivery to a customer device 14. The customer, identified by customer ID 16, may receive an offer on the mobile device 12 for delivery of content 18 to a customer device 14. Example mobile devices include cellular phones, satellite phones, personal digital assistants (PDA), personal email devices (e.g., a Blackberry-type device), and even portable computers. The customer device 14 may be separate and apart from the mobile device 12, and may in fact be at a different location. Examples of customer devices may include personal computers, set-top boxes, digital televisions, etc. The selection of the content 18 offered to the customer 16 may be based, at least partially, on the customer profile 20.

The GPS satellite 22 is a satellite that is well-known in the art for sending signals for computing devices to determine their location on the surface of the Earth. The mobile network 24 may be a mobile network providing voice, and/or data and/or video communication such as the type of network commercially used by large mobile service providers. The Internet 26 may be used to connect the customer device and server, although it will be appreciated that other networks may also be used. The satellite network 28 is a video and/or data and/or voice system that includes a satellite for delivery. There are many satellite networks 28 used by service providers. A gateway one 30 may be configured to convert to/from the mobile network 24 to the Internet 26. The gateway two 32 may be configured to convert from the Internet 26 to/from the satellite network 28.

The mobile device 12 includes a customer id 16, a location system 34, an input device 36, and a display device 38, the last three of which are communicatively coupled with one another. The location system 34 includes a location 42. The location is the location of the mobile device 12 on the surface of the Earth. The location system 34 determines the location 42 of the mobile device 12 on the surface of the Earth. In one example embodiment, the location system 34 determines the location 42 of the mobile device 12 on the surface of the Earth by using received signals from the GPS satellite 22, although it will be appreciated that other location detection approaches may also be employed. In another embodiment, the location system 34 determines the location 42 of the mobile device 12 on the surface of the Earth by using received signals from the mobile network 24. The input device 36 is a key board, touch screen, or any of the input devices 36 well-known in the art for computer devices, e.g., the input device 36 could be a microphone with the processor of the mobile device 12 disposed for voice recognition. The display device 38 is an LCD screen or other type of display well-known in the art for computer devices. The display device 38 has a size 40 which is indicative of how much content 18 can be offered on the display device 38. The mobile device 12 further includes an offerer 43. The offerer 43 may include specialized software to receive offers from the server 44 and present the offers to the customer 16. In one example embodiment, the offerer 43 may be provided using a instant message program. The offeror 43 may be provided using software, e.g., an intelligent agent, or other component provided on the mobile device as resident software, or as executable client content downloaded via a network connection using various protocols, e.g., a wireless access protocol. A customer software agent may also be provided in the mobile device, or elsewhere on the system, to act on behalf of the customer and to conduct transactions with the offeror 43. The offerer 43 may include a software component that includes a user interface configured to present the offers from the server 44. The offerer 43 may be configured to communicate directly with the download manager 50.

The server 44 may include an aggregate data 46, customer profile 20, content 18, and matcher 38. The server 44 may be a computing device with a CPU, memory, storage, and a network attachment device, e.g., a conventional computer system with additional software configured to facilitate the performance of the procedures described in the present application. Aggregate data 46 may include data that may be useful to determine content 18 to offer to the customer 16. Aggregate data 46 may also include such data as statistics for all reviews of the content 18 from all the customers. The customer profile 20 may include data concerning the customer, such as demographic data, customer history, or other data that may be useful to determine content 18 to offer to the customer 16. The customer profile 20 may include such data as the age of the customer. The content 18 may be videos. The matcher 38 is software that uses the aggregate data 46 and the customer profile 20 to match content 18 to offer to the customer 16. The matcher 38 also downloads the content 18 to the user device 14.

The customer device 14 includes a download manager 50, storage 52, and a presentation device 54, which may be provided in a single unitary device, or as separate components in communication with each other. For example, the customer device 14 may be a set-top box. The customer device 14 sends and receives data using the Internet using a device such as an Ethernet attachment or a broadband cable connection, although it will be appreciated that other communication networks and devices may also be provided. The customer device 14 may send and receive data using the satellite network 28 using a device such as a satellite receiver. The download manager 50 is software that manages the download of the content 18 to the storage 52. The presentation device 54 may be, e.g., a passive screen such as a projection television. Alternatively, the presentation device 54 may be, e.g., a separate computing device that includes a screen, such as a laptop computer in communication with the customer device 14 through, for example, a local area network in the home of a customer 16.

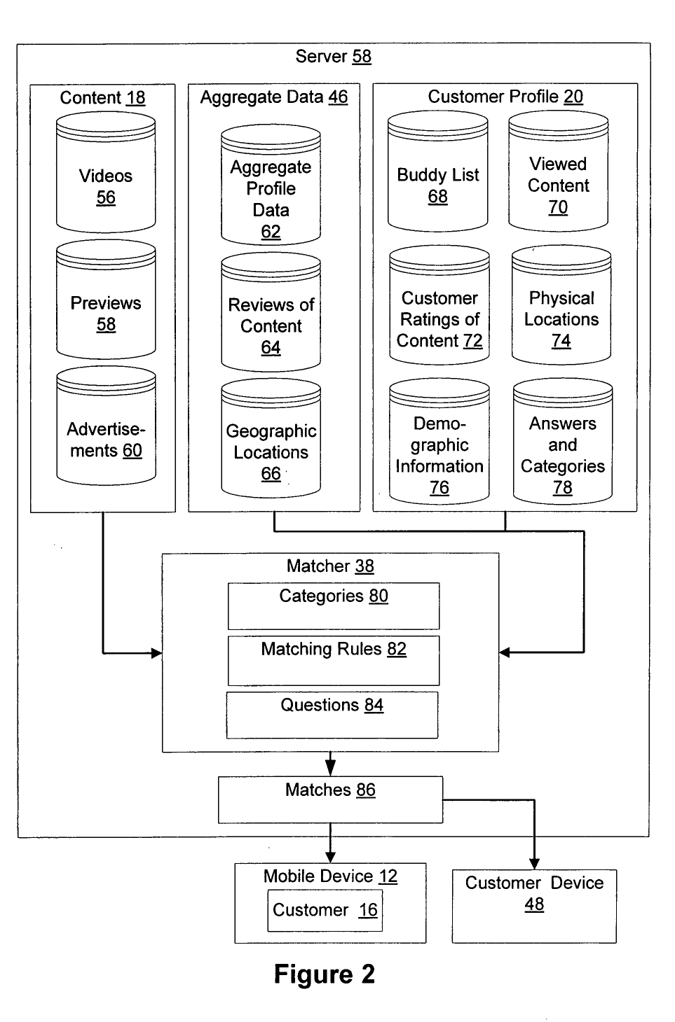

FIG. 2 depicts the server 58 in more detail. The content 18 may include videos 56, previews 58, and advertisements 60. The videos 56 may be movies, documentaries, or any type of content for consumption by the consumer 16 on the customer device 14. The previews 58 may be the movie trailer produced for a released movie, or may be a preview 58 that has been produced for a mobile device 12. The previews 58 may be interactive. The advertisements 60 may be any type of advertisement meant for consumption on the mobile device 12 or the customer device 48. For example, the advertisements 60 may be banner advertisements, video advertisements, and may also be interactive.

The aggregate data 46 may include aggregate profile data 62, reviews of content 64, and geographic locations 66, as well as other data related to multiple customers and content. The aggregate profile data 62 may be data that is derived from the customer profiles 20 such as the number of times a video 56 has been viewed and a customer profile 20 of the type of customers that have viewed the video 56. The reviews of content 64 may be reviews 64 by customers 16 of the videos 56, or they may be external reviews 64, e.g., critics or customers 16 of other services. Geographic locations 66 may be a mapping from a geographic location 66 to an identification for the geographic location 66, e.g. the geographic location 66 of all the football stadiums in the U.S. could be stored.

The customer profile 20 may include buddy list 68, viewed content 70, customer ratings of content 72, physical locations 74, demographic information 76, and answers and categories 78. The customer profile 20 is for one customer, identified by customer ID 16. The buddy list 68 may be other customers the customer indicates are buddies. The viewed content 70 may be the content 16 that the customer 16 has viewed. The content 18 may be content 18 the customer 16 has viewed from other sources. The customer ratings of content 72 may be the rating of content 18 the customer 16 has viewed. Physical locations 74 may be a set of locations 42 that the mobile device 12 has been. The demographic information 76 may be such information as the age, sex, etc. of the customer 16. The answers and categories 78 may be the answers to questions asked of the customer 16, and may be categories that the customer 16 has been identified with.

The data stored on the server 58 is illustrated in a particular configuration for ease of explanation. The data stored on the server 58 could easily be organized differently, for example all the data could be in one database. Further, the data stored on the server 58 may be stored remotely and the data does not need to be stored all in the same place, so for example some data could be stored locally on the server 58, and some data could be stored remotely. Some of the data may be obtained from a remote server, for example, advertisements 60 may be obtained from a remote server.

The matcher 38 may include categories 80, matching rules 82, and questions 84. The matcher 38 may be provided as a software component and data that uses the aggregate data 46 and the customer profile 20 to match content 18 to produce matches 86 to offer to the customer 16 on the mobile device 12. The matcher 38 may be configured to interact with the customer 16 and to download the content 18 to the customer device 48.

The categories 80 are categories 80 such as “football” or “mysteries” that are matched to the customer 16 and to the content 18. The matcher 38 may use the categories 80 as an indication that content 18 that belongs to the same category 80 as a customer 16 may be a good match for the customer 16. The matcher 38 may determine the categories by scanning the text describing the content 18, e.g., if the description of a video 56 contains “football”, the matcher 16 may infer that the video 56 contains content related to “football” and make the video 56 part of the category 80 “football”. The matcher 16 may determine a category for a customer 16 by examining the physical locations 74 a customer 16 has been and determining that a physical location 74 matches the geographic locations 66 of a football stadium. The matcher 38 may then infer that the customer 16 likes football and make the customer 16 a memory of the category “football.”

The matching rules 82 may be any type, in either software or hardware, and may be used to match the content 18 to the customer 16, customer profile 20 and aggregate data 46. The matching rules 82 can be in the form of a general purpose language, in the form of a production rules, in the form of the hard-coded logic, or any of various other forms. Some examples of matching rules 82 may be “if a customer has been to two or more football games (as determined by their geographic location or from the answer to questions, then put the customer in the category of football.” Another example of a rule may be, “if the customer's home address is in the south, put them in the category of southern.” Another rule may be “if the customer did not like a movie that had a category of southern, and the customer is in the category of southern, ask the customer if the customer likes southern movies.”

The questions 84 may be any question 84 that the matcher 38 queries the customer 16. Some example of questions are “do you like football?”; “Would you like to view <insert title of content>”; “Do you like to watch long movies?”; etc. Alternatively, instead of questions asked to the customer, customer attributes may also be inferred from other information available about a particular customer or a class of customers.

It will be appreciated that part of the information that is used in identifying the content to offer to a customer may come from demographic information about the customer, part from information about the customer's content purchases, and part may also come from customer history from other services. For example, in one alternative embodiment, part of the information used by the matcher 38 to determine what content to offer to a customer may be information reflecting the customer's viewing history on the Internet. So for example, the Internet viewing history may show that the customer has chosen to accesses information over the Internet related to particular sports events, teams, or players. Based on this access history, highlight films or game replays from those events, teams, or players may be offered to the customer. Using data mining techniques, other correlations between customer Internet viewing history may also be discovered and exploited to provide help refine the content selection rules.

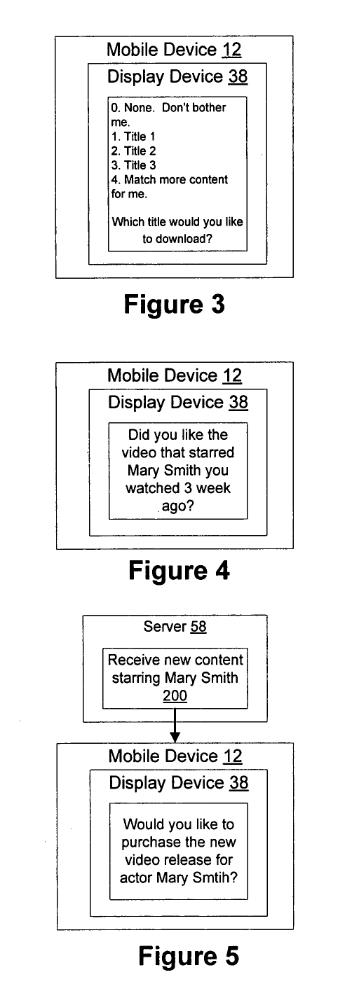

FIG. 3 depicts an example screen display, according to an example embodiment of the present invention. The example screen may be displayed on the display device 38 of the mobile device 12 querying the customer 16 if the customer 16 would like to download one of the matched content 18. The number of matched content 18 has been sized to fit on the display device 38. The customer 16 may be given the option to request not to be queried for the option of downloading more content 18, and the customer 16 may be given the option of matching more content 18.

FIG. 4 depicts a second example screen display, according to an example embodiment of the present invention. The example screen may be displayed on the display device 38. The customer 16 is being queried whether the customer 16 enjoyed content 18 the customer 16 has downloaded. The answer to the query will be used to determine new content 18 to offer to the customer 16.

FIG. 5 depicts an example query process, according to an example embodiment of the present invention. The server 58 receives new content 18. In response to having received new content 18, the customer 16 is offered the new content 18. Before offering the customer the content, the server may have identified the customer as a suitable customer for the new content through the application of the matcher, although new content offers may alternatively be broadcast to all customers.

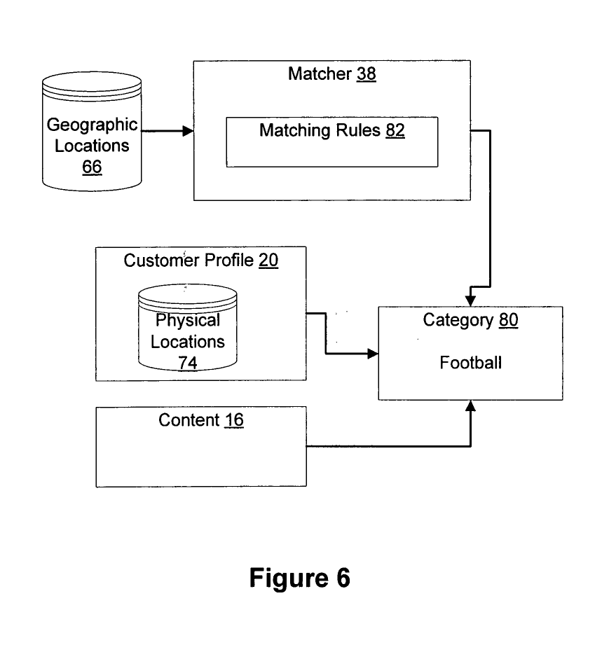

FIG. 6 depicts an example data flow, according to an example embodiment of the present invention. The matcher 38 associated the customer 16 with the category 80 “football” because the matcher 38 determined that the customer 16 had attended a football game (a) based on the geographic locations 74 the customer 16 has been and (b) based on the geographic locations 66 of football stadiums. The matcher 38 may also have the times when football games are played and may determine concert attendances, the type of football, e.g., major league, minor league, who the cheerleaders were, the teams that played, etc. The matcher 38 associated the content with the category 80 “football” as well. The matcher 38 may have associated the content 16 with the category 80 based on the text description of the content 16 or based on received categories of the content 16. The matcher 38 may have recognition techniques that examine the content 16 and determine categories 16 based on identifying elements of the content 16, e.g., a football.

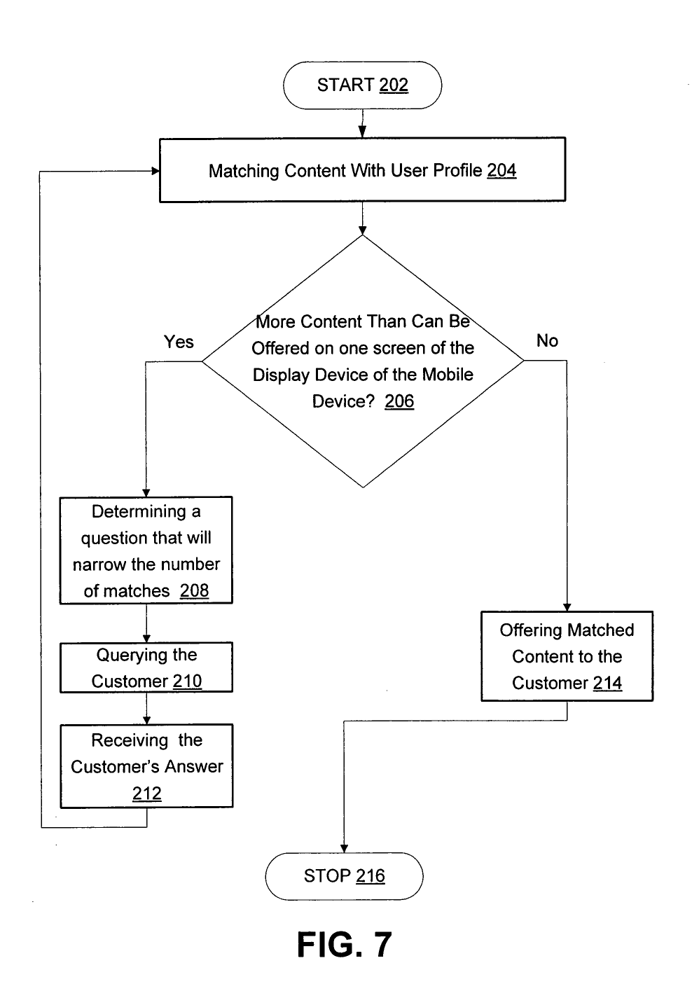

FIG. 7 depicts an example flowchart illustrating sizing the matched content 16 in proportion to the size 40 of the display device 38 of the mobile device 12, according to an example embodiment of the present invention. The method starts at 202. The method continues at 204 with matching content with the customer profile. The flow continues at 206 with determining whether more content has been matched than can be displayed on the one screen of the mobile device. In other embodiments, the matches may be two screens or some amount of content based on the screen size of the mobile device. The flow continues at 208 when there is more content than can be displayed on one screen of the mobile device with determining a question that will narrow the number of matches. An example question may be, “Do you like football?” The matcher 38 may determine the question by searching for questions that will provide the most information regarding the preferences of the customer 18 with regard to the current matched content 16. The flow continues at 210 with querying the customer. For example, the matcher 38 will send the question to the mobile device 12 for the customer 16 to consume. The flow continues with receiving the customer's answer 212. For example, the matcher 38 will receive an answer from the customer 16. The flow continues at 214 with offering the matched content to the customer. The flow stops at 216.

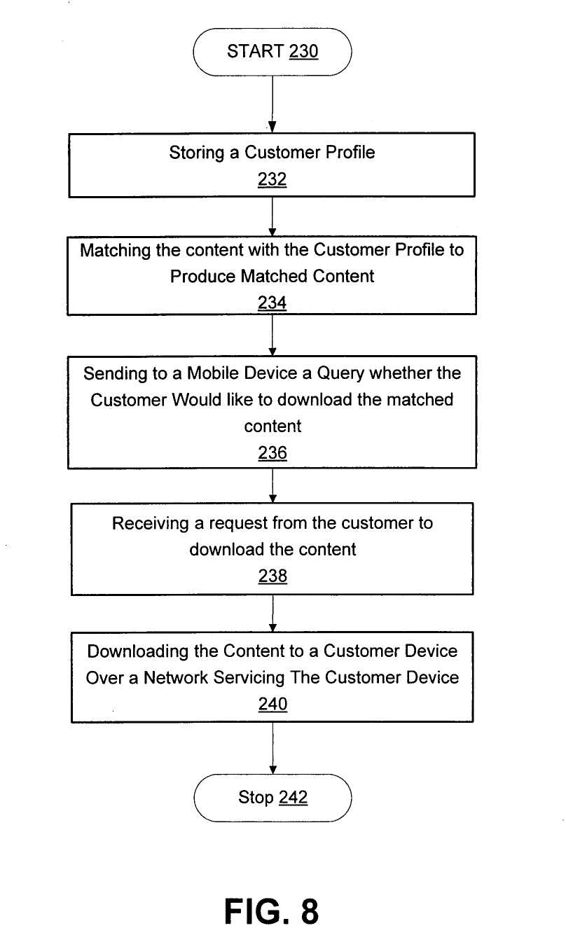

FIG. 8 depicts a flowchart for an example method for offering content to a customer on a mobile device for delivery to a customer device, according to an example embodiment of the present invention. The flow starts at 230. The flow continues at 232 with storing a customer profile. For example, the customer profile 20 may include items that are part of the membership page. The flow continues at 234 with matching the content with the customer profile to produce matched content. For example, the matcher 38 may match the content 18 with the aggregate data 46 and the customer profile 20. The flow continues at 236 with sending to a mobile device a query whether the customer would like to download the matched content. An example screen was illustrated in FIG. 3. The flow continues at 238 with receiving a request from the customer to download the content. For example, in FIG. 3, the customer 16 may select 3 which would then be transmitted via the mobile network 24 to the server 44. The flow continues at 240 with downloading the content to a customer device over a network servicing the customer device. For example, the matcher 38 may download the selected content 18 to the customer device 48 over the Internet 26. This may be a high-definition movie for example. The customer may then view or access the content at a later time on the customer device. It will be appreciated that the downloading may even precede the arrival of the customer at the customer device. The flow then stops at 242.

It should now be apparent that a system and method for ordering content on a mobile device has been described.

It will be appreciated that all of the disclosed methods, processes, and procedures described herein can be implemented using one or more computer programs or computer program components. These components may be provided as a series of computer instructions on any conventional computer-readable medium or other tangible medium, including RAM, ROM, flash memory, magnetic or optical disks, optical memory, or other storage media. The instructions may be configured to be executed by a processor, which when executing the series of computer instructions performs or facilitates the performance of all or part of the disclosed methods, processes, and procedures.

In the preceding specification, the present invention has been described with reference to specific example embodiments thereof. It will, however, be evident that various modifications and changes may be made thereunto without departing from the broader spirit and scope of the present invention as set forth in the claims that follow. The specification and drawings are accordingly to be regarded in an illustrative rather than restrictive sense.

What is claimed is:

1. A method for delivering content to a customer device, comprising:
storing a customer profile;
matching the content with the customer profile to produce matched content;
sending to a mobile device via a network servicing the mobile device a query whether the customer would like to download the matched content;
responsive to the query, receiving a request from the customer to download the content; and
responsive to the request, downloading the content to the customer device over a network servicing the customer device.

2. The method of claim 1, wherein the mobile device is a cell phone.

3. The method of claim 1, wherein the content is video.

4. The method of claim 1, wherein sending to a mobile device, further comprises:
sending a preview of the content to the mobile device.

5. The method of claim 1, wherein matching further comprises:
receiving new content at the server;
matching the new content with the customer profile; and
responsive to the matching, sending to the mobile device a query whether the customer would like to download the matched content.

6. The method of claim 1, wherein matching further comprises:
matching a category to a customer based on the customer profile;
matching the category to the content; and
matching the customer profile to the content based on the matched category.

7. The method of claim 6, wherein the customer profile information is selected from the group consisting of: customer demographic information, customer indicated preferences, customer viewing history, and customer purchase history for non-content purchases, customer viewing history at an Internet Website.

8. The method of claim 1, wherein matching further includes:
sending to the mobile device a query to determine whether the customer is a member of a category;
receiving from the customer a response to the query; and
modifying a customer profile based upon the user response to the query.

9. The method of claim 1, wherein the network servicing the customer device is different than the network servicing the mobile device.

10. The method of claim 1, wherein the customer device is a set-top box.

11. The method of claim 1, further comprising:
selecting advertising based on the content; and
embedding advertising in the content before downloading the content.

12. The method of claim 1, further comprising:
inferring a category for the customer based on the customer profile.

13. The method of claim 12, further comprising:
receiving a location on the surface of the Earth of the mobile device; and
inferring a category for the customer based on the location.

14. The method of claim 1, further comprising:
receiving location information from the mobile device; and
inferring a category of the customer from the location information received from the mobile device.

15. The method of claim 1, wherein sending further comprises:
sending to an instant messenger program.

16. The method of claim 1, wherein the matching is based on at least the preferences of a buddy of the customer.

17. The method of claim 1, wherein the customer profile includes preferences and requests for alerts configurable by the customer.

18. The method of claim 1, wherein matching further comprises:
narrowing the matched content based on a size of a display of the mobile device.

19. The method of claim 1, wherein matching further comprises:
repeating until the matched content can be offered on one screen of the mobile;
sending to the mobile device a query to determine whether the customer is a member of a category;
receiving from the customer a response to the query; and
narrowing the matched content based upon the user response to the query.

20. The method of claim 1, wherein the mobile device is a cell phone and the content is video and wherein the network servicing the customer device is different than the network servicing the mobile device, and the customer device is located at a location different geographical location than a present geographical location of the mobile device, the method further comprising:
receiving new content at the server;
matching the new content with the customer profile based on customer profile information, the customer profile information including the customer's viewing history at an Internet Website; and
the sending to the mobile device the query is performed responsive to the matching.

21. An article of manufacture comprising a computer-readable medium having stored thereon instructions configured to be executed by a processor, the instructions configured to, when executed by the processor, to cause the performance of a method including:
storing a customer profile;
matching the content with the customer profile to produce matched content;
sending to a mobile device via a network servicing the mobile device a query whether the customer would like to download the matched content;
responsive to the query, receiving a request from the customer to download the content; and
responsive to the request, downloading the content to the customer device over a network servicing the customer device.

22. The article of claim 21, wherein the mobile device is a cell phone and the content is video and wherein the network servicing the customer device is different than the network servicing the mobile device, and the customer device is located at a location different geographical location than a present geographical location of the mobile device, the method further including:
receiving new content at the server;
matching the new content with the customer profile based on customer profile information, the customer profile information including the customer's viewing history at an Internet Website; and
the sending to the mobile device the query is performed responsive to the matching.

23. A system, comprising:
a customer mobile device configured, responsive to receipt of a notification, to present a customer with the opportunity to order a newly available content, the mobile device further configured, responsive to a customer input indicating the customer's desire to order the newly available content, to send a message indicating the customer's desire order the newly available content;
a second customer device separate and apart from the customer mobile device; and
a server in communication via a network with the customer mobile device and the second customer device, the server configured to receive the newly available content and to send, via the network, the notification of newly available content to the customer mobile device, the server further configured, responsive to receipt of the message to cause the content to be downloaded to the second customer device.

24. The system of claim 21, further comprising:
a software component configured to receive customer attribute information, and based on the customer attribute information, to select the newly available content from a set of newly available content.

25. The system of claim 22, wherein the customer attribute information includes information reflecting the customer's Internet viewing history.
